(19) United States
(12) Patent Application Publication
(10) Pub. No.: US 2002/0151629 A1
(43) Pub. Date: Oct. 17, 2002

(54) Protective coating

(76) Inventors: Halbert C. Buffkin, Martinsville, VA (US); Albert R. Mersberg, Martinsville, VA (US)

Correspondence Address: Kolisch, Hartwell, Dickinson, McCormack & Heuser, 200 Pacific Building, 520 S.W. Yamhill Street, Portland, OR, 97204, US

(21) Appl. No.: 10/071,573

(22) Filed: Feb. 8, 2002

Related U.S. Application Data
(60) Provisional application No. 60/267,563, filed on Feb. 8, 2001.

(51) Int. Cl. C08K 5/09

(52) U.S. Cl. 524/284

(57) ABSTRACT

Compositions and methods for coatings that are curable to a protective film. In one aspect, the compositions may include a reactive diluent that is a carboxylic acid compound. In another aspect, the compositions may include alkyd and acrylic resins. Concentrated dispersion, alkyd, and coalescence compositions are also provided along with methods for making and using these compositions to produce a coating composition.

### CROSS REFERENCE TO RELATED APPLICATIONS

This application is based upon and claims benefit under 35 U.S.C. §119 from the following U.S. Provisional Patent Application, which is incorporated herein by reference: Serial No. 60/267,563, naming Halbert C. Buffkin and Albert R. Mersberg, filed Feb. 8, 2001.

### FIELD OF THE INVENTION

The present invention relates generally to coating compositions, and more particularly to coating compositions that are curable to a protective film.

### BACKGROUND

Polymeric coatings have a vast array of uses including paints, inks, sealants, and adhesives. One function of these coatings is to protect and insulate a more vulnerable material from exposure to the elements. For example, the exterior hulls of marine vessels are exposed to constant immersion in corrosive, high salinity water and to the constant forces exerted by water movement, in some cases violent pounding forces. Many marine vessels are constructed of corrosion-sensitive metal alloys, thus it is essential to provide a curable coating that can withstand the harsh conditions imposed by ocean travel, while protecting the underlying material from corrosion or other degradation.

Many curable coatings that may be suitable for application to marine vessels include organic solvents to maintain hydrophobic components in solution and to allow these components to react efficiently. Examples of such solvents include toluene and xylene. However, since these organic solvents are generally volatile, their release into the atmosphere during curing has created considerable concern about the harmful effect of the solvents on the environment. For example, the United States Environmental Protection Agency (EPA) has set stringent standards that must be met in order for a coating composition to be designated as VOC-free. Currently, EPA test 24 requires coating compositions to contain less than 30 g/liter volatile organic compounds to be deemed VOC-free. In response to the EPA standards and other government regulations, coatings manufacturers have increasingly attempted to decrease the fraction of volatile organic compounds (VOCs) in coating compositions.

Efforts to decrease VOCs in coating compositions have generally focused on replacing VOCs with non-volatile solvents and water, while still providing hydrophobic components in the composition as emulsions or dispersions. Surfactants and coalescents have been used to facilitate joining of the hydrophobic components in such emulsions and dispersions into a film during curing. For example, water-based acrylic latex coating compositions include a dispersion of resin particles and a coalescent to join the resin particles. However, these water-based acrylic coating compositions cure to produce a film with a lattice-like pattern. Non-uniformity of latex films is at least partially a result of phase discontinuity in acrylic coating compositions immediately after application and during subsequent curing. Therefore, water-based acrylic compositions do not usually cure to provide the uniform protective barrier necessary for greatest durability, adhesion, and shielding of the underlying substrate from harmful influences, such as salt water in the example presented above. An acrylic coating composition that is VOC-free and cures to a highly adhesive, uniform, and thus water-impervious film would benefit many. Therefore, it would be useful to identify non-volatile hydrophobic compounds, detergents, resins, or mixtures that would facilitate more efficient curing of acrylic resins into uniform films.

An alkyd is an example of a hydrophobic resin that is frequently used in coating compositions. An alkyd may be oxidatively cured during air-drying to provide a protective film. Nevertheless, preparation of an alkyd usually creates a solid or high viscosity liquid, non-aqueous mixture that is not readily transferred to, or emulsified in, an aqueous setting. To overcome this property of alkyds, others have attempted to dilute alkyds with a reactive diluent. In general, a reactive diluent for a resin (binder) decreases the viscosity of the resin, may prevent the resin from undergoing a phase change at room temperature, and facilitates the introduction of the resin into an aqueous environment. In addition, a reactive diluent reacts with the resin during the curing process to become part of the cured film. For example, U.S. Pat. No. 4,798,859 of Hohlein et al., U.S. Pat. No. 5,008,336 of Richey Jr. et al., U.S. Pat. No. 5,248,717 of Mathai, and U.S. Pat. No. 6,130,275 of Gracey et al., each of which is incorporated by reference, describe reactive diluents for alkyds.

The various reactive diluents described by others are generally inadequate for the formulation of coating compositions that are VOC-free and that cure to durable, adherent films. The present invention provides an advantageous reactive diluent, and selected VOC-free coating compositions that typically cure to highly durable, scrub-resistant, and adherent films that transmit water vapor at rates significantly less than standard latex films.

### SUMMARY OF THE INVENTION

The present invention provides coating compositions that are curable to a protective film. In one aspect, the present invention includes a reactive diluent for coating compositions. In another aspect, the present invention provides concentrated sub-compositions including dispersion, alkyd, and coalescence compositions that facilitate the preparation of the coating compositions of the present invention. A method for making coating compositions from the concentrated sub-compositions is also described.

### BRIEF DESCRIPTION OF THE DRAWINGS

FIG. 1 is a flowchart of a method for making a coating composition according to the present invention.

### DETAILED DESCRIPTION

Coating compositions of the present invention generally include a binder, a reactive diluent, and coalescents, and also typically include pigments, coupling agents, and other optional additives. These ingredients may be assembled through the use of sub-compositions, including a dispersion composition, an alkyd composition, and a coalescence composition. The dispersion composition facilitates wetting and dis-agglomeration of pigments and other insoluble particulates. The alkyd composition, through use of the reactive diluent, facilitates introduction of an alkyd into the coating composition. Finally, the coalescence composition adds coalescing agents that aid in curing the coating composition to a protective film.

The coating compositions of the present invention are typically free of volatile organic compounds and may be air-cured at ambient temperature to produce a protective film. In some embodiments curing may be mediated, or accelerated by any suitable means, such as by heat or ultraviolet radiation. Furthermore, the coating compositions are typically applied to a metal or metal alloy, but any suitable substrate may be used, including a wood product, paper, plastic, or concrete.

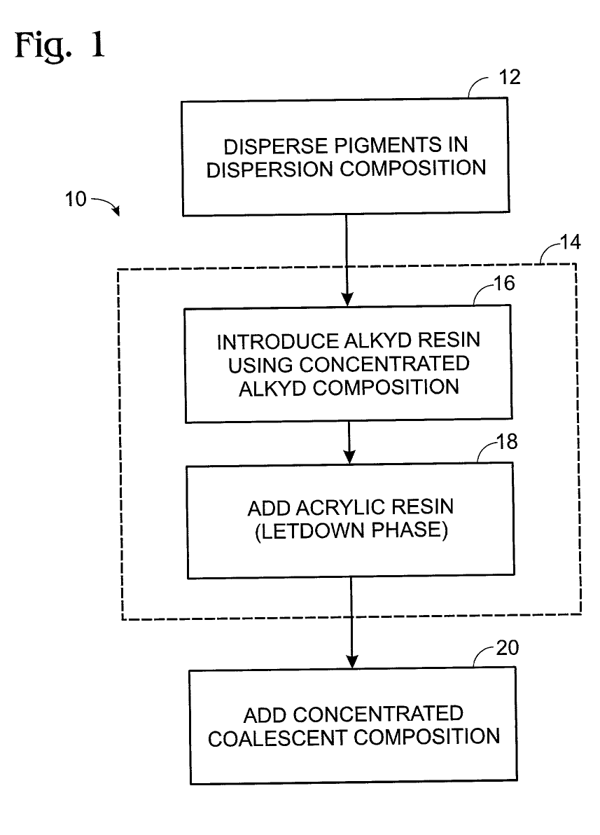

A method of making a coating composition in accordance with the present invention is shown in FIG. 1. Method 10 uses one or more concentrated compositions, as fully described in the following sections, to introduce components for pigment dispersion, resin addition and/or emulsion, and coalescence. As shown at step 12, pigments are dispersed and generally wetted and dis-agglomerated by mixing the pigments with a dispersion composition to produce a pigment mixture. This dispersion portion of method 10 may also be referred to as a grind phase. The present invention provides a concentrated dispersion composition that may be diluted with water, and optionally detergent and other additives, to create a dispersion composition suitable for pigment dispersion.

As shown at step 14, at least one resin is added to provide a binder for the coating composition. In this example, alkyd is introduced at step 16 as a concentrated composition that is diluted significantly during preparation of the coating composition. The concentrated alkyd composition may include a reactive diluent. At least one resin, in this case an acrylic resin, may be added at step 18, at letdown phase, as part of a letdown composition. The letdown composition may include water; water and resin; or water, resin, and additives as defined below. In general, a letdown composition is any composition that increases water content of a dispersed pigment mixture by 50% or more. As shown at step 20, one or more coalescents may be added to the mixture as a concentrated coalescent composition that is diluted significantly during coating composition production.

The remainder of the Detailed Description describes the present invention according to the following topic headings: A) Reactive Diluent; B) Coating Composition; C) Alkyd and/or Acrylic Coating Composition; D) Dispersion Composition; E) Concentrated Alkyd Composition; F) Concentrated Coalescence Composition; and Examples.

A. Reactive Diluent

In one aspect, the invention includes a reactive diluent. A reactive diluent is any compound or mixture of compounds that has a relatively low viscosity, is capable of diluting components (usually resins) of a coating composition, and reacts with one or more components of a coating composition to become incorporated into the film that is produced by curing the coating composition. A reactive diluent may be useful with high viscosity or solidifying resins to facilitate mixing these resins into the coating composition.

The reactive diluent of the present invention may be an organic acid, which in combination with a binder, may be used to produce a VOC-free coating composition that is curable in air. In one embodiment, the reactive diluent of the invention is a carboxylic acid with the formula R¹—(C═O)—OH, where the R¹ moiety has 8 to 35 carbons, and may be saturated or include one or more unsaturated carbon-carbon bonds. Furthermore, the R1 moiety may be unsubstituted or substituted one or more times, including substitution by hydroxy groups. The R¹ moiety may incorporate at least one ester linkage of the form —(C═O)—O— or —O—(C═O)—, and may have 13 to 27 carbons, or 18 to 23 carbons. When an ester linkage is present in the reactive diluent, the reactive diluent is described as an ester acid or an ester carboxylic acid.

R¹ of the reactive diluent may have the following formula: R²—(C═O)—O—R³—. R² is a moiety having 3 to 23 carbons, 8 to 21 carbons, 13 to 19 carbons, 15 to 17 carbons, or 17 carbons. R² may be saturated or include one or more unsaturated carbon-carbon bonds, and may be unsubstituted or substituted one or more times, including substitution by hydroxy groups. R² (and the attached, esterified carbon) may be provided by a synthetic mixture of at least two fatty acids derived from linseed oil, or R² and the attached carbon may be provided by a natural mixture of the fatty acids present in linseed oil.

The R³ moiety is a linker having 1 to 16 carbons, 1 to 8 carbons, 1 to 6 carbons, 2 to 4 carbons, or 2 carbons. R³ is optionally saturated or unsaturated, and may be substituted or unsubstituted.

One form of the reactive diluent may be produced as the ester condensation product of 1) a fatty acid or mixture of fatty acids and 2) a hydroxy carboxylic acid, although any suitable synthetic route may be used to make the reactive diluent. A fatty acid is any carboxylic acid compound, whether synthetic, naturally-occurring, or created by a combination of these routes, where the carboxyl group is linked to a saturated or unsaturated, straight or branched hydrocarbon chain, optionally substituted with moieties such as hydroxy groups, or unsubstituted. Fatty acids include compounds with 4 to 24 carbons. The fatty acid or mixture of fatty acids may come from a natural source. Suitable natural sources for ester condensation to produce the reactive diluent may include fatty acids derived from corn, coconut, babassu, olive, peanut, perilla, linseed, tung, and castor oils; fatty acids obtained from drying oils; or a mixture of fatty acids from linseed oil. Linseed oil may be a commercially desirable source of chemically suitable fatty acids because of its low cost.

A hydroxy carboxylic acid is any carboxylic acid compound with a hydroxy group bonded to a carbon atom, where the carbon atom is distinct from the carboxyl group. The hydroxy carboxylic acid may have two to seventeen carbons. The hydroxy group may be on the 2-position of a hydroxy carboxylic acid, or on 2-hydroxy propanoic acid, which is also known as lactic acid. In one form, the reactive diluent may correspond to the ester condensation product of linseed oil fatty acids and a substantially equimolar amount of lactic acid. A substantially equimolar ratio of fatty acids:lactic acid is about 0.8:1 to about 1.5:1.

B. Coating Composition

The reactive diluent of the present invention may be useful in the coating composition presented in Table 1. Each ingredient or component of this table, and all other tables in this Description, includes three different concentration ranges that may be used. These concentration ranges are given as a weight/weight percentage. The first, second, and third concentration ranges listed for each component are intended to be considered independently for each ingredient or component.

The coating composition of Table 1 includes a binder and a reactive diluent, and typically includes pigments, and other additives. These components are dispersed, emulsified, or dissolved in an aqueous medium to create a coating composition that may be VOC-free. The water content may be about 20% to about 70%, about 25% to about 55%, or about 30% to about 50%.

TABLE 1
Coating Composition (% ingredient by weight)

| Ingredients | Ranges | | |
|---|---|---|---|
| binder | 3-55 | 5-50 | 8-40 |
| reactive diluent | 0-15 | 0.1-10 | 0.5-5 |
| pigment/additives | 0-80 | 10-75 | 30-70 |
| water | 20-70 | 25-55 | 30-50 |

A suitable binder includes any components that inter-link or substantially solidify during curing to create a cured film. The binder may be present at about 3% to about 55%, about 5% to about 50%, or about 8% to about 40% by weight. The binder may be a single binder or a mixture of binders.

The binder is typically a polymer or resin. Examples of polymer or resin solutions, dispersions, or emulsions that may be useful in the invention may be selected from, for example, polymers of alkyl esters of acrylic or methacrylic acid such as methyl methacrylate, ethyl methacrylate, butyl methacrylate, ethyl acrylate, butyl acrylate, hexyl acrylate, n-octyl acrylate, lauryl methacrylate, 2-ethylhexyl methacrylate, nonyl acrylate, benzyl methacrylate, the hydroxyalkyl esters of the same acids such as 2-hydroxyethyl acrylate, 2-hydroxyethyl methacrylate, and 2-hydroxypropyl methacrylate, the nitrile and amides of the same acids such as acrylonitrile, methacrylonitrile, and methacrylamide, vinyl acetate, vinyl propionate, vinylidene chloride, vinyl chloride, and vinyl aromatic compounds such as styrene, t-butyl styrene and vinyl toluene, dialkyl maleates, dialkyl itaconates, dialkyl methylene-malonates, isoprene, butadiene, chlorinated propylene and copolymers therof. Suitable polymers containing carboxylic acid groups may include polymers derived from acrylic monomers such as acrylic acid, methacrylic acid, ethacrylic acid, itaconic acid, maleic acid, fumaric acid, monoalkyl itaconate including monomethyl itaconate, monoethyl itaconate, and monobutyl itaconate, monoalkyl maleate including monomethyl maleate, monoethyl maleate, and monobutyl maleate, citraconic acid, and styrene carboxylic acid. Other polymers may include ethyl cellulose, nitrocellulose, linseed oil-modified alkyds, rosin-modified alkyds, phenol-modified alkyds, phenolic resins, polyesters, poly(vinyl butyral), polyisocyanate resins, polyurethanes, polyamides, chroman resins, dammar gum, ketone resins, maleic acid resins, poly(tetrafluoroethylene-hexafluoropropylene), low-molecular weight polyethylene, phenol-modified pentaerythritol esters, copolymers with siloxanes and polyalkenes. These polymers may be used either alone or in combination. The polymers may be crosslinked or branched. In some embodiments, the binder is an alkyd, an alkyd mixed with an acrylic resin, or a linseed oil-modified alkyd. Alkyds, also referred to as alkyds, are more fully described below in relation to the coating composition of Table 2.

The reactive diluent of the invention is used in the coating composition of Table 1 at a non-zero concentration of up to about 15%, about 0.1% to about 10%, or about 0.5% to about 5% by weight. A weight ratio of alkyd:reactive diluent of from about 5:1 to about 1:5, 3:1 to about 1:2, or about 3:2 to about 2:3 may be used in all coating compositions of the present invention.

Coating compositions of the present invention optionally include pigment. Pigment includes any particulate components of the coating composition that are distinct from the binder. Pigment may include particulates that change the appearance of the coating composition or cured film, that act as fillers or extenders to reduce the amount of other components required or to reduce the cost of the coating composition, or that alter the physical properties of the coating composition or cured film. Examples of physical properties other than color that may be altered by pigments include corrosion sensitivity, UV resistance, or mar resistance. Pigments that may suitable are described more fully below in relation to the coating composition of Table 2.

Coating compositions of the present invention usually include additives. Additives may include any other substance or material that is included to produce a suitable coating composition. For example, additives may be used to modify the smell, appearance, physical properties, thixotropy, rheological properties, cure rate, or cure quality of the coating composition or resulting cured film. Examples of additives that may be suitable in the invention include coupling agents, coalescents, detergents, pH modifiers, drying agents, wet-edge modifiers, wet adhesion modifiers, freeze-thaw stabilizers, thixotropes, defoaming agents, or biocidal agents. Definitions, ranges, and examples of additives are presented below.

Pigments and additives may be included in coating compositions of the present invention at up to about 80%, at about 10% to about 75%, or about 30% to about 70%, by weight.

C. Alkyd and/or Acrylic Coating Composition

Table 2 lists ingredients of another coating composition, according to the present invention. This coating composition is a water-based mixture that uses water as vehicle at about 05% to about 60%, 25% to about 55%, or about 30% to about 50%, by weight. Although VOCs may be added to some formulations for specific needs, coating compositions produced according to the present invention typically include less than 30 grams per liter VOCs, which is defined as VOC-free.

The coating composition of Table 2 may include an alkyd, an acrylic resin, or a mixture of alkyd and acrylic resins. The composition typically includes reactive diluent and suitable additives including coupling agents, coalescents, pigments, detergents, pH modifiers, drying agents, wet-edge modifiers, freeze-thaw stabilizers, defoaming agents, biocidal agents and bodying agents.

TABLE 2
Coating Composition (% by weight)

| | | | | EXAM- |
|---|---|---|---|---|
| Ingredients | Ranges | | | PLE 11 |
| alkyd | 0-15 | 0.5-10 | 1-5 | 2.8 |
| reactive diluent | 0-15 | 0.5-10 | 1-5 | 2.8 |
| acrylic resin | 0-40 | 2-20 | 5-15 | 9.3 |
| coupling agent | 0-2 | 0.002-0.5 | 0.005-0.20 | 0.02 |
| coalescent | 0-5 | 0.03-1.0 | 0.1-0.5 | 0.21 |
| pigment | 0-80 | 10-60 | 30-55 | 42.8 |
| detergent | 0-5 | 0.05-2.0 | 0.1-1 | 0.4 |
| pH modifier | 0-5 | 0.1-2 | 0.2-1 | 0.5 |
| drying agent | 0-0.3 | 0.02-0.25 | 0.05-0.15 | 0.07 |
| wet edge modifier | 0-5 | 0.001-.50 | 0.01-0.20 | 0.07 |
| freeze-thaw stabilizer | 0-1 | 0.003-0.3 | 0.01-0.1 | 0.03 |
| defoaming agent | 0-3.0 | 0.05-2.0 | 0.1-1.0 | 0.6 |
| biocidal agent | 0-2.0 | 0.01-0.8 | 0.05-0.4 | 0.14 |
| bodying agent | 0-5.0 | 0.5-3.0 | 1.0-2.0 | 1.3 |
| water | 20-60 | 25-55 | 30-50 | 40.8 |

i. Alkyds and Reactive Diluent

Coating compositions that are made according to the present invention may include a non-zero amount of an alkyd at up to about 15%, about 0.5% to about 10%, or about 1% to about 5%. As used herein, an alkyd is any resin produced from the reaction of a polybasic carboxylic acid, a polyol, and a fatty acid. Examples of suitable polybasic acids include phthalic anhydride, isophthalic acid, terephthalic acid, succinic acid, adipic acid, sebacic acid, tetrahydrophthalic acid, maleic acid, maleic anhydride, fumaric acid, itaconic acid, and citraconic anhydride.

A polyol is any polyhydric alcohol including two or more hydroxy groups per molecule. Suitable polyols may include glycerol, ethylene glycol, diethylene glycol, triethylene glycol, polethylene glycol, propylene glycol, trimethylene glycol, tetramethylene glycol, trimethylolpropane, neopentyl glycol, diglycerin, triglycerin, penthaerythritol, dipentaerythritol, mannitol and sorbitol. Typically, the polyol used in alkyd preparation is glycerol, or an oil derivative thereof.

A fatty acid is any carboxylic acid compound, whether synthetic, naturally-occurring, or a combination thereof, where a carboxyl group is linked to a saturated or unsaturated, straight or branched hydrocarbon chain. Fatty acids are compounds that have 4 to 24 carbons. In addition, fatty acids have hydrocarbon chains may be modified with other moieties such as hydroxy groups. In the present invention, the polyol and fatty acids may be provided in an esterified form, esterified as oils, or as dehydrated or partially saponified oil derivatives. Suitable oils for use in the present invention include non-drying and semi-drying oils such as coconut oil, palm oil, olive oil, castor oil, rice oil or cotton oil. Drying oils such as soybean oil, tang oil, or linseed oil are used more commonly.

Alkyds may be described as short oil, medium oil, or long oil. Oil length is a measurement of the percentage oil content by weight in the alkyd. A medium oil length is defined as 45%-55% oil content, with long oil alkyds>55% and short oil alkyds<45%. Primer coating compositions produced according to the present invention may include a short oil alkyd, and a topcoat composition may include a medium oil alkyd.

Coating compositions of the present invention may include the reactive diluent described above for the coating composition of Table 1. Reactive diluent may be included in the coating composition described in Table 2 at a non-zero amount of up to about 15% by weight, about 0.5% to about 10%, or about 1% to about 5%.

ii. Acrylic Resins

Coating compositions of the present invention may include an acrylic resin. Acrylic resin may be included in a coating composition at a non-zero amount of up to about 40%, about 2% to about 20%, or about 5% to about 15%. A suitable acrylic resin typically has a glass transition temperature high enough to maintain the desired hardness at the range of temperatures at which the resulting protective film will be used, selected from the range of about 10° C. to about 300° C. Suitable acrylic resins may include pure acrylic resins, an epoxy acrylate hybrid system, a copolymer of acrylic acid and acrylic acid ester, or combinations with vinyl resins or copolymers with vinyl monomers, such as vinyl acetate, styrene or butadiene. Acrylic resins are typically included in coating compositions of the present invention as particulate dispersions with suitable particle sizes selected from the range commonly used in acrylic latex paints. An acrylic resin that has been used successfully in an embodiment of the invention is UCAR LATEX 626, which is offered by Union Carbide Corp., Danbury, Conn.

A surface hardener may be included in some embodiments of the present invention, for example, as part of a concentrated coalescent composition that is added during production of the coating composition (see below). A surface hardener may include any material that forms part of the surface film and increases the overall hardness of the film. A suitable type of surface hardener is a very hard acrylic resin. During curing a very hard acrylic resin may become part of the forming film, but may provide a dull surface finish to the cured film. Therefore, surface hardeners are optional components of a coating and are generally used in low luster or flat coatings. Although any suitable hard acrylic resin may be used as a surface hardener, a powdered thermoplastic resin, B-66 ACRYLOID has been used successfully. B-66 ACRYLOID is a copolymer of methyl and butyl methacrylates from Röhm-America, Inc., of Piscataway, N.J.

iii. Coupling Agents

One or more coupling agents may be included in coating compositions of the present invention at a non-zero concentration of up to about 2%, about 0.002% to about 0.5%, or about 0.005% to about 0.20%. Coupling agents may be used to promote several properties of the coating composition. For example, coupling agents may facilitate the wetting of inorganic or organic pigments and other additives during the grind or dispersion phase of coating composition production. In this role coupling agents may function to provide a shorter grind/dispersion time. Second, they may aid in the emulsion of alkyds, reactive diluent, acrylic resin, or other hydrophobic components in an aqueous mixture. Third, coupling agents may play a coupling role by uniting reactive moieties. Fourth, coupling agents may act as catalysts in electron transfer reactions. Fifth, coupling agents may improve adhesion between pigment and binder, producing a stronger film.

Coupling agents, also called hypersurfactants, are typically organometallic derivatives that include the metals titanium, zirconium, or silicon. Alternatively, coupling agents may include titanium or zinc, or may be organo-titanate or organo-zirconate coupling agents, or a combination thereof, such as the coupling agents described in U.S. Pat. No. 4,087,402, filed Apr. 19, 1976; U.S. Pat. No. 4,080,353, filed Jan. 30, 1976; U.S. Pat. No. 4,122,062, filed Sep. 30, 1975; U.S. Pat. No. 4,227,415, filed Aug. 29, 1979; U.S. Pat. No. 4,623,738, filed Apr. 22, 1985; and U.S. Pat. No. 4,634,785, filed Jan. 6, 1987. These patents are hereby incorporated by reference in their entirety. Coupling agents that may be suitable for use in the coating compositions and concentrated sub-compositions of the present invention are available from Du Pont under the name TYZOR and from Kenrich Petrochemicals, Inc., Bayonne, N.J. Although structurally similar compounds may be used from any source, coupling agents that have been used successfully in embodiments of the present invention are available from Kenrich. These coupling agents include KEN-REACT KR 55, a coordinate titanate; KEN-REACT LICA 38, a neoalkoxy titanate; KEN-REACT LICA 12, a neoalkoxy titanate; KEN-REACT KZ 55, a coordinate zirconate; and KEN-REACT NZ 38, a neoalkoxy zirconate.

iv. Coalescents

Coating compositions of the present invention may include a non-zero amount of a coalescing agent, also referred to as a coalescent, at a concentration of up to about 5%, about 0.03% to about 1%, or about 0.1% to about 0.5% by weight. A coalescent is any compound that directly promotes uniting resin molecules into a film, and usually becomes incorporated into the film.

In the coating compositions of the present invention, coalescing agents may include one or more low molecular weight (typically monomer) multi-functional acrylate cross-linkers. Monomer multi-functional acrylate cross-linkers may be included at about 0.001% to about 0.5%, about 0.003% to about 0.25%, or about 0.01% to about 0.1%, by weight. Low molecular weight tri-functional cross-linkers that have been used successfully in preparing compositions of the present invention include SR-444 and SR-9035 from Sartomer, Company, Inc., Exton, Pa. SR-444 is pentaerythritol triacrylate, and includes a pendant hydroxy group, whereas SR-9035 is ethoxylated (15) trimethylolpropane triacrylate. SR-444 may be more suitable in applications where a harder film or reduced water sensitivity is required. In contrast, SR-9035 may be suitable in applications where trace amounts of formaldehyde release are unacceptable.

In addition to multi-functional acrylate monomers, a monofunctional acrylate monomer may be used to facilitate cold temperature coalescence at temperatures near freezing. Such a cold-temperature coalescent may be included at a non-zero amount of up to about 0.5%, about 0.01% to about 0.4%, or about 0.03% to about 0.3% by weight. A cold-temperature coalescent acrylate monomer that may be suitable for this purpose is SR-495. SR-495 is available from Sartomer Company and is a monofunctional monomer of caprolactone acrylate.

Coating compositions of the present invention may also include a polyether polyol or copolyether polyol as a coalescing agent. The term polyether polyol is also meant to include copolyether polyols hereafter. Polyether polyols may be included at about 0.02% to about 2%, about 0.05% to about 1%, or about 0.1% to about 0.5%, by weight. Examples of polyether polyols and copolyether polyols, and their use in coatings, are described in U.S. Pat. No. 5,708,058, filed Sep. 25, 1996, and U.S. Pat. No. 5,883,180, filed Nov. 9, 1995, which are hereby incorporated by reference in their entirety. Polyether polyols are the reaction products of one or more alkylene oxides and one or more aliphatic polyol, where the polyol includes 2 to 8 carbons. The resulting ethers may include up to 20 or more added alkoxy groups. In the present invention a polyether polyol may be an ethoxylated polyol, an alkoxylated butanol, an ethoxylated butanol, or a butoxypolyglycol such as BUTOXYPOLYGLYCOL BASIC, which is available from Union Carbide Corporation, Danbury, Conn.

v. Pigments

Coating compositions of the present invention may include at least one pigment. Pigment may be included in the coating composition at a non-zero amount of up to about 80%, about 10% to about 60%, or about 30% to about 55%, by weight. Pigment includes all particulate ingredients that are added to the coating composition and are distinct from binder, and may include functional properties listed above for pigment of Table 1.

Any suitable inorganic pigments may be used, for example titanium dioxide, zinc oxide, basic lead sulfate, calcium plumbate, zinc phosphate, aluminum phosphate, zinc molybdate, calcium molybdate, yellow lead, synthetic yellow iron oxide, transparent red oxide, titanium yellow, zinc yellow, strontium chromate, red oxide, red lead, chrome vermillion, basic lead chromate, chromium oxide, Prussian blue, ultramarine blue, cobalt blue, calcium carbonate, barium sulfate, talc, clay, silica, mica, graphite, iron black, and carbon black.

Any suitable organic pigments may also be used, such as monoazo red, quinacridone Red, monoazo red Mn salt, monoazo Bordeaux Mn salt, monoazo maroon Mn salt, anthanthrone red, anthraquinonyl red, perylene maroon, quinacridone Magenta, perylene Red, diketopyrrolopyrrole, benzimidazolone orange, quinacridone Gold, monoazo yellow, cis-azo Yellow, isoindolinone yellow, metal complex salt azo yellow, quinophthalone yellow, benzimidazolone yellow, copper phthalocyanine green, brominated phthalocyanine green, copper phthalocyanine blue, indanthren Blue, dioxane violet, fast yellow group, permanent yellow HR, acetanilide type monoazo yellow, Lake Red 4R, Permanent Carmine FB, Brilliant Fast Scarlet, Pyrrazolone Red B, Watchung Red metal salts, Lithol Red Ba salt, Brilliant Carmine 6G, Bordeaux 10B, and Rhodamine 6G Lake.

Anti-corrosives are any additives that prevent corrosion of an underlying substrate, and are categorized as pigments. The coating composition may include anti-corrosives that act as rust inhibitors by oxidation in place of a metal substrate on which the coating composition has been applied. Anti-corrosives may be included at a non-zero amount of up to about 60%, about 5% to about 50%, or about 15% to about 40%, by weight. Although any anti-corrosives may be suitable, anti-corrosives that have been used successfully in embodiments of the present invention include zinc oxide, SW MOLY WHITE 501, available from Sherwin-Williams, and HALOX Z-PLEX 111, a zinc phosphate complex available from Halox, of Hammond, Ind. Sodium nitrite may be added to inhibit flash rusting at about 0.01% to about 1%, about 0.03% to about 0.5%, or about 0.05% to about 0.3% by weight. Anti-corrosives may not be required in coating compositions that are applied to non-rusting materials such as wood.

vi. Detergents and pH Modifiers

Coating compositions of the present invention may include one or more detergents at a non-zero concentration of up to about 5%, about 0.05% to about 2%, or about 0.1% to about 1%. Detergents may include any ionic, polyelectrolyte, or non-ionic molecule with hydrophobic and hydrophilic portions. Detergents may function to lower surface tension and facilitate wetting of some pigments. In addition they may facilitate the formation of emulsions or solubilization of hydrophobic components. Detergents for pigment dispersion are well known in the art. Detergents that have been used successfully in embodiments of the present invention include TRITON CF-10 (Union Carbide, of Danbury, Conn.) or TAMOL 850 (Rohm and Haas).

The pH of coating compositions of the present invention may be adjusted by including a non-zero amount of a pH modifying agent with basic properties, up to about 5%, about 0.1% to about 2%, or about 0.2% to about 1% by weight. The pH modifying agent may include ethylenic unsaturation, or may be a dialkylaminoakyl acrylate or methacrylate. Illustrative of these acrylates are 2-dimethylaminoethyl- and 2-diethylaminoethyl-acrylate or -methacrylate, 2-dimethylaminopropyl- and 2-diethylaminopropyl-acrylate or -methacrylate, 2-tert-butylaminoethyl-acrylate or -methacrylate, and the 3-dialkylamino-2,2-dimethylpropyl-1 acrylates and -methacrylates. Coating compositions of the present invention may include a tertiary amine neutralizing agent, 3,3-dimethylaminopropyl methacrylamide, abbreviated as DMAPMA (RhonePoulenc, Inc.). DMAPMA and related tertiary amines have been suggested to promote wet adhesion as described in U.S. Pat. No. 4,582,730 , filed Jan. 28, 1985, and U.S. Pat. No. 5,312,863, filed Mar. 20, 1992, both of which are hereby incorporated by reference.

Ammonium hydroxide may be included as a pH modifier at a non-zero amount up to about 1%, 0.02% to about 0.5%, or about 0.05% to about 0.25%. In addition, ammonium hydroxide may be included to adjust the final pH of a coating composition to about 8.0 to about 9.5, about 8.5 to about 9.2, or about 8.8 to about 8.95.

Potassium tripolyphosphate (KTPP) may be included with a pH modifier to help stabilize the pH. KTPP may be included at a non-zero concentration of up to about 2%, about 0.05% to about 1%, or about 0.2% to about 0.6%. KTPP that has been used successfully in selected embodiments of the present invention was obtained from Brenntag Southwest, Inc., of Longview, Tex.

vii. Drying Agents and Wet-Edge Modifiers

Drying agents may be included in coating compositions of the present invention at a non-zero concentration of up to about 0.3%, about 0.02% to about 0.25%, or about 0.05% to about 0.15%, by weight. Drying agents are any compounds that facilitate oxidative curing of the coating composition during exposure to air. Generally, drying agents catalyze cross-linking of fatty acid chains in an alkyd, but may catalyze any other reaction that promotes oxidative curing. Drying agents suitable for use in the present invention may include water emulsifiable driers such as cobalt alkanoate and manganese naphthenate, available as NUOCURE COBALT 10% and NUOCURE MANGANESE 6% from CONDEA Servo LLC, Piscataway, N.J.

Wet-edge modifiers may be included in coating compositions of the present invention at a non-zero concentration of up to about 5%, about 0.001% to about 0.25%, or about 0.01% to about 0.10%, by weight. A wet-edge modifier is any substance that temporarily inhibits the curing process after application of the coating composition or that helps otherwise stabilize the coating composition. This type of modifier may assist in applying a uniform layer of the coating composition, by preventing premature curing during the application process. A suitable wet-edge modifier may be 4-hydroxy-3-methoxybenzaldehyde, commonly known as vanilla or vanillin, combined with a polyether polyol. Vanillin may be combined with a polyether polyol, including vanillin at about 0.10% to about 10%, 0.30% to about 3%, or about 0.5% to about 2%. This vanillin/polyether polyol (wet-edge modifier) mixture may be included in the coating composition at a non-zero concentration of up to about 5%, about 0.001% to about 0.50%, or about 0.01% to about 0.20%, by weight. Overall, vanillin may be included in coating compositions of the present invention at about 0.0001% to about 0.010%, about 0.0002% to about 0.005%, or about 0.0005% to about 0.003%, by weight. Polyether polyols are described above under Coalescents. A wet-edge modifier may contribute not only functional properties, but vanilla produces a characteristic aroma during the curing process that may provide pleasant associations.

viii. Freeze-Thaw Stabilizers, and Defoaming, Biocidal, and Bodying Agents

Coating compositions of the present invention may include a freeze-thaw stabilizer, at a non-zero concentration of up to about 1%, about 0.003% to about 0.3%, or about 0.01% to about 0.1%. A freeze-thaw stabilizer may protect the coating composition from cold weather damage and thus may increase the shelf-life and stability of the composition. The freeze-thaw stabilizer may include a polyvinyl alcohol. A polyvinyl alcohol used successfully in embodiments of the invention is AIRVOL*103 from Air Products and Chemicals, Inc., Allentown, Pa.

One more more defoaming agents may be included in coating compositions of the present invention at a non-zero concentration of up to about 3%, about 0.05% to about 2%, or about 0.1% to about 1% by weight. Defoaming agents are any compounds or mixtures that prevent the initial formation of foam or act to destabilize it once formed. These agents may minimize trapped air that could affect the evenness of application or otherwise adversely alter the quality of the cured film produced after application. PATCOTE 841, available from American Ingredients Co., Kansas City, Mo. and DEE FO XJH-123 from Ultra Additives Inc., Paterson, N.J. have been used as defoaming agents in coating composition embodiments.

Biocidal agents may be included in coating compositions of the present invention at a non-zero concentration of up to about 2%, about 0.01% to about 0.8%, or about 0.05% to about 0.4%, by weight. Biocidal agents are any substances that inhibit growth of micro-organisms in a coating composition, or in or on the cured film produced after application of the coating composition. An anti-bacterial agent, 2-((hydroxymethyl)amino) ethanol, available under the name NUOSEPT 91 from Hüls America Inc., Piscataway, N.J., has been used in embodiments of the invention.

Coating compositions of the present invention may include a bodying agent, at a non-zero concentration of up to about 5%, at about 0.5% to about 3%, or about 1% to about 2%, by weight. A bodying agent is any agent that changes the apparent viscosity of a material. One example of a bodying agent is an associative thickener, a compound or mixture that increases the viscosity of any mixture that includes a partner or partners for association with the bodying agent, but decreases the viscosity otherwise, through dilution. A suitable bodying agent may be UCAR POLYPHOBE TR-117 from Union Carbide Corporation, Danbury, Conn.

D. Dispersion Composition

The present invention provides a concentrated dispersion composition that is useful in preparing coating compositions according to the invention, as shown in FIG. 1. When diluted, the dispersion composition is capable of efficiently wetting and dispersing most pigments. Specifically, with standard mixing equipment and methods well known to those in the art, pigment compositions may be sufficiently dis-agglomerated with the diluted dispersion composition in ten minutes or less. Therefore, dispersion compositions made in accordance with the present invention may offer a significant savings in time. Furthermore, the dispersion composition described herein may facilitate production of VOC-free coating compositions of the invention.

The ranges of ingredients suitable for producing a concentrated dispersion composition in accordance with the present invention are given in Table 3. Definitions and example of each ingredient of the composition of Tables 3-5 are given above for the coating compositions of Tables 1 and 2. The concentrated dispersion composition may be diluted by weight about 10-fold to about 2000-fold, about 50-fold to about 1000-fold, or about 100-fold to about 500-fold, using water, pigment, and optionally detergent and other additives, prior to, or during, dispersion of pigment. In a coating composition ready for application, the concentrated dispersion may have been diluted about 50-fold to about 2000-fold, about 100-fold to about 1000-fold, or about 200-fold to about 600-fold.

A coupling agent is included in the concentrated dispersion composition of the present invention at about 1% to about 30%, about 2% to about 15%, or about 3% to about 10%, by weight. A polyether polyol may also be included at about 3% to about 60%, about 5% to about 50%, or about 15% to about 40%, by weight, and may be included as a wet-edge modifier, as described above. The weight ratio of coupling agent to polyether polyol may be about 1:50 to about 2:1, about 1:25 to about 1:1, or about 1:10 to about 1:2. A pH modifier may be included at about 2% to about 60%, about 4% to about 40%, or about 6% to about 20%, by weight. The weight ratio of coupling agent to pH modifier may be about 5:1 to about 1:20, about 2:1 to about 1:10, or about 1:1 to about 1:4. Vanillin may be included at a non-zero concentration of up to about 3%, about 0.05% to about 2%, or about 0.2% to about 0.8%, by weight. A freeze-thaw stabilizer may be included at a non-zero concentration of up to about 20%, about 1% to about 10%, or about 2% to about 8%, by weight. Water and other additives may be included at about 20% to about 70%, about 30% to about 60%, or about 40% to about 50%.

TABLE 3
Concentrated Dispersion Composition (% by weight)

| Ingredients | Ranges | | | EXAMPLE 1 |
|---|---|---|---|---|
| coupling agent | 1-30 | 2-15 | 3-10 | 6.3 |
| polyether polyol | 3-60 | 5-50 | 15-40 | 31.7 |
| pH modifier | 2-60 | 4-40 | 6-20 | 12.7 |
| vanillin | 0-3 | 0.05-2 | 0.2-0.8 | 0.35 |
| freeze-thaw | 0-20 | 1-10 | 2-8 | 4.4 |
| water/additives | 20-70 | 30-60 | 40-50 | 44.8 |

As exemplified in EXAMPLE 3 below, a concentrated dispersion composition may be used to disperse and dis-agglomerate pigments during the grind phase of preparing a coating composition. Typically, the concentrated dispersion composition of Table 3 is diluted with water, and optionally detergent, additional pH modifier, and other additives, before or during its use to disperse pigment. Therefore, more dilute dispersion compositions may be prepared directly, diluted appropriately and used in pigment dispersion, as an alternative to the concentrated composition of Table 3.

An alternative concentrated dispersion composition is presented in Table 4. Table 4 shows concentration ranges for an alternative concentrated dispersion composition that may be diluted by weight about 2-fold to about 400-fold, about 10-fold to about 200-fold, or about 20-fold to about 80-fold, using water, pigment, and optionally detergent and other additives. The dispersion composition of Table 4 may include coupling agent at about 0.2% to about 6%, about 0.4% to about 3%, or about 0.6% to about 2%. A polyether polyol may be included at about 0.6% to about 12%, about 1% to about 10% or about 3% to about 8%. A pH modifier may be included at about 0.4% to about 12%, about 0.8% to about 8%, or about 1.2% to about 4%. Vanillin may be included at a non-zero concentration of up to about 0.6%, about 0.01% to about 0.4%, or about 0.04% to about 0.16%. A freeze-thaw stabilizer may be included at a non-zero concentration of up to about 4%, about 0.2% to about 2%, or about 0.4% to about 1.6%. Water and other additives may be included at about 70% to about 99%, about 76% to about 99% or about 84% to about 95%.

Dispersion compositions listed in Tables 3 and 4 and other dispersion compositions of the present invention may be described as follows. A dispersion composition may be thought of as a two part system, although not necessarily generated by mixing these two parts. The first part includes a coupling agent, and may include a polyether polyol, a pH modifier, vanillin, a freeze-thaw stabilizer, water, or additives according to the indicated ranges listed in Table 3 and described above. The second part of the dispersion composition substantially or completely includes water and may also include additives. The second part may constitute up to about 80%, or up to about 95% of the dispersion composition by weight.

Table 5 shows the ingredient ranges that may be included in a dispersion mixture subsequent to dilution with water, pigments, and other additives, including additional pH modifier. A coupling agent may be included at a concentration of about 0.004% to about 1.2%, about 0.008% to about 0.4%, or about 0.012% to about 0.07%. A polyether polyol may be included at about 0.012% to about 2.4%, about 0.02% to about 0.5%, or about 0.06% to about 0.3%. A pH modifier may be included at about 0.1% to about 10%, about 0.2% to about 4%, or about 0.5% to about 2%. Vanillin may be included at up to about 0.12%, about 0.0002% to about 0.03%, or about 0.0008% to about 0.0032%. A freeze-thaw stabilizer may be included at up to about 0.8%, about 0.004% to about 0.04%, or about 0.008% to about 0.032%. Water plus pigment may be included at about 93% to about 99.9%, about 98% to about 99.9% or about 99.5 to about 99.9% by weight. Water and pigment may be included at a weight ratio of water:pigment of about 1:15 to about 5:1, about 1:10 to about 2:1, or about 1:6 to about 1:1.

TABLE 4
Alternative Concentrated Dispersion Composition (% by weight)

| Ingredients | Ranges | | |
|---|---|---|---|
| coupling agent | 0.2-6 | 0.4-3 | 0.6-2 |
| polyether polyol | 0.6-12 | 1-10 | 3-8 |
| pH modifier | 0.4-12 | 0.8-8 | 1.2-4 |
| vanillin | 0-0.6 | 0.01-0.4 | 0.04-0.16 |
| freeze-thaw | 0-4 | 0.2-2 | 0.4-1.6 |
| water/additives | 70-99 | 76-99 | 84-95 |

TABLE 5
Dispersion Mixture
(after dilution with water, pigments, and additives; % by weight)

| Ingredients | Ranges | | |
|---|---|---|---|
| coupling agent | 0.004-1.2 | 0.008-0.4 | 0.012-0.07 |
| polyether polyol | 0.012-2.4 | 0.02-0.5 | 0.06-0.3 |
| pH modifier | 0.1-10 | 0.2-4 | 0.5-2 |
| vanillin | 0-0.12 | 0.0002-0.03 | 0.0008-0.032 |
| freeze-thaw | 0-0.8 | 0.004-0.04 | 0.008-0.032 |
| water/pigment | 93-99.9 | 98-99.9 | 99.5-99.9 |

E. Concentrated Alkyd Composition

A concentrated alkyd composition that may be suitable for use in producing a VOC-free coating composition in accordance with the present invention is given in Table 6. The definitions and descriptions of the ingredients that may be used are as outlined above for the coating compositions. In preparing a coating composition, the alkyd composition may achieve a final dilution of about 2-fold to about 100-fold, about 5-fold to about 50-fold, or about 10-fold to about 25-fold. Upon dilution into a pigment/dispersion mixture during preparation of a coating composition, the diluted alkyd composition, referred to as an alkyd emulsion or alkyd mixture, may have been diluted about 2-fold to about 40-fold, about 3-fold to about 25-fold, or about 5-fold to about 15-fold.

An alkyd is included, and a reactive diluent may be included, in the concentrated alkyd composition. The total concentration of alkyd plus reactive diluent in the alkyd composition may be about 20% to about 98%, with alkyd present at about 10% to about 80%, about 30% to about 60%, or about 35% to about 50%. In addition, reactive diluent may be included at about 10% to about 80%, about 30% to about 60%, or about 35% to about 50%. A weight ratio of alkyd:reactive diluent of from about 5:1 to about 1:5, 3:1 to about 1:2, or about 3:2 to 2:3 may be used in the concentrated alkyd composition of the present invention. The alkyd may be produced by a drying oil, or by tung oil or linseed oil.

One or more coupling agents may be included in the concentrated alkyd composition at about 0.5% to about 15%, about 2% to about 10%, or about 4% to about 8%. A detergent may be included in the alkyd composition at about 0.01% to about 3%, about 0.05% to about 2%, or about 0.1% to about 1%. A pH modifier may be included in the alkyd composition at about 0.5% to about 10%, about 1% to about 8%, or about 2% to about 5%. One or more drying agents may be included in the alkyd composition at a non-zero concentration of up to about 2%, about 0.05% to about 1%, or about 0.1% to about 0.5%, by weight.

TABLE 6
Alkyd Composition (% by weight)

| Ingredients | Ranges | | | EXAMPLE 5 |
|---|---|---|---|---|
| alkyd | 10-80 | 30-60 | 35-50 | 44.7 |
| reactive diluent | 10-80 | 30-60 | 35-50 | 44.7 |
| coupling agents | 0.5-15 | 2-10 | 4-8 | 6.3 |
| detergents | 0.01-3 | 0.05-2 | 0.1-1 | 0.7 |
| pH modifiers | 0.5-10 | 1-8 | 2-5 | 3.4 |
| drying agents | 0-2 | 0.05-1 | 0.1-0.5 | 0.3 |

F. Concentrated Coalescence Composition

A coalescence composition that may be suitable for use in producing a VOC-free coating composition in accordance with the present invention is presented in Table 7. The definitions and descriptions of the ingredients that may be used are as given above for the coating compositions. The coalescence composition may be used in a coating composition at a dilution of at least about 50-fold, about 100-fold to about 3000-fold, about 250-fold to about 1500-fold, or about 400-fold to about 1000-fold. Addition of the coalescence composition at an effective dilution promotes a substantial increase in curing rate, at least two-fold.

The coalescence composition may include a polyether polyol at about 5% to about 90%, about 40% to about 80%, or about 60% to about 75%. An acrylate monomer may be included at about 2% to about 50%, about 5% to about 40%, or about 10% to about 30%. The acrylate monomer may include one or more multi-functional acrylate monomers. An acrylic resin may be included at a non-zero concentration of up to about 20%, about 2% to about 15%, or about 5% to about 10%. The acrylic resin may be a surface hardener. Vanillin may be included at a non-zero concentration of up to about 2%, about 0.05% to about 1%, or about 0.1% to about 0.6%. The vanillin:polyether polyol ratio may be about 1:10 to about 1:1000, about 1:33 to about 1:333, or about 1:50 to about 1:200.

TABLE 7
Coalescence Composition (% by weight)

| Ingredients | Ranges | | | EXAMPLE 7 |
|---|---|---|---|---|
| polyether polyol | 5-90 | 40-80 | 60-75 | 69.1 |
| acrylate monomer | 2-50 | 5-40 | 10-30 | 22.8 |
| acrylic resin | 0-20 | 2-15 | 5-10 | 7.8 |
| vanillin | 0-2.0 | 0.05-1.0 | 0.1-0.6 | 0.3 |

The following specific examples illustrate preparation of concentrated compositions, sub-compositions, and coatings compositions in accordance with the invention. “Parts” refers throughout to parts by weight and is a measure of ingredient ratios for a specific composition or sub-composition.

### EXAMPLE 1

This example illustrates the preparation of a concentrated dispersion composition. This composition is preferably used in a coating composition that cures to produce a flat or eggshell finish.

Composition A is prepared by heating Butoxypolyglycol Basic (90 parts) to about 50-66° C. Powdered vanillin (1 part) is added and the mixture is stirred until a clear brown solution is produced. Composition A is cooled to room temperature before use.

Composition B is prepared by heating water (0.9 part) to 70-77° C. AIRVOL*103 polyvinyl alcohol (0.1 part) is added with mixing and stirred until a whitish solution is produced. Composition B is cooled to room temperature before use.

Composition C is prepared by combining and mixing DMAPMA (2 parts) and KEN-REACT NZ-38 (1 part). Upon mixing, this composition releases a significant amount of heat, and thus it may be immediately used in formation of Composition D to help dissipate the heat (see below).

Composition D is prepared by adding in order with mixing: 445 parts Composition B, 325 parts Composition A, 130 parts Composition C, 50 parts water, and 3 parts DEE FO XJH-123. The resultant Composition D is a concentrated dispersion composition suitable for dilution with water, and optionally other compounds or mixtures. When diluted, as illustrated in EXAMPLE 3, Composition D is effective for grinding many kinds of pigments.

### EXAMPLE 2

This example illustrates the preparation of a concentrated dispersion composition. This composition is preferably used in a coating composition that cures to produce a semi-gloss or high gloss finish.

Composition E is first prepared by mixing DMAPMA (2 parts) with KEN-REACT LICA 38 (1 part). Upon mixing, this composition releases significant heat, and thus Composition E (1 part) is immediately added to Composition B of EXAMPLE 1 (1 part) with mixing to produce Composition F, while cooling Composition E. Composition F is a concentrated dispersion composition suitable for dilution with water, and optionally other compounds or mixtures. Composition F may be diluted to produce a composition effective for grinding pigments.

### EXAMPLE 3

This example illustrates dilution of a concentrated dispersion composition to wet and dis-agglomerate pigments.

The following are combined in order with gentle agitation: water (270.85 parts), PATCOTE 841 defoamer (10.58 parts), Composition D from EXAMPLE 1 (7.41 parts), DMAPMA (8.99 parts), TRITON CF-10 (6.77 parts), and NUOSEPT 91 (2.49 parts). The resultant Composition G is an efficient grind composition for pigment wetting and dispersion and is a VOC-free composition.

To grind pigments and other additives, Composition G (307.1 parts) is mixed at higher speed and the following are added in order: titanium dioxide, (type rutile; 338.57 parts), APC-453 Synthetic Yellow Oxide (Alabama Pigments Co., Green Pond, Ala; 80.41 parts), zinc oxide 414W (1.06 parts), UCAR POLYPHOBE TR-117 (4.23 parts), NYTAL-200 (talc from RT Vanderbilt and Co.; 211.61 parts), MINEX-10 Silica (529.01 parts), water (181.98 parts), SW MOLY WHITE 501 (1.06 parts), and SW-111 HALOX (105.80 parts). The resultant composition is Composition H. High speed mixing is continued until the desired Hegman value is achieved. A Hegman value of 4 is generally achieved in about 5-10 minutes using standard mixing equipment and speeds known to those in the art.

### EXAMPLE 4

This example illustrates a method for preparing a reactive diluent of the invention. A sidearm vacuum flask is charged with linseed oil fatty acid (229.17 parts) and KEN-REACT KR-55 (2.92 parts). The mixture is heated to about 150° C. under vacuum with constant agitation. Lactic acid (100.83 parts) is added slowly from a sidearm addition graduate under continued vacuum and constant temperature maintenance. The liquid is not allowed to boil or froth during this addition phase. After all the lactic acid has been added, the mixture is heated for an additional 30-45 minutes. After the mixture cools it is ready for use in the following examples. The final product is predominantly the reactive diluent, fatty acid (linseed oil) 1-carboxyethyl esters, and a small amount of fatty acid (linseed oil) 2-(carboxyethoxy)-1-methyl-2-oxoethyl esters. The amount of this latter diester is determined, at least in part, by the molar excess of lactic acid over linseed oil fatty acids.

Higher temperatures and a distinct catalyst may be substituted in the above reaction. Dibutyloxo stannane is a suitable alternative to KEN REACT KR 55 at a temperature of about 200° C. without vacuum. The reaction performed under these conditions produces an extremely dark mixture that is not desirable in white or off-white color formulas. In contrast, the use of a more active catalyst, such as KEN REACT KR 55, coupled with vacuum and lower temperatures as described above, produces a more lightly colored mixture.

### EXAMPLE 5

This example illustrates the production of a short oil alkyd suitable for use in a coating composition, more preferably a composition useful as a primer. A side-arm flask is charged with tung oil (10 parts), isophthalic acid (3.5 parts), and KEN-REACT KZ-55 (0.035 parts). The mixture is heated to 150° C. and maintained at this temperature for a time sufficient to effect formation of the alkyd, usually about 6 to 8 hours. Reactive diluent (6.67 parts) from EXAMPLE 4 is added and the mixture is cooled to room temperature to provide Composition I.

To create a concentrated short oil alkyd composition suitable for use as part of a coating composition, Composition I (707 parts) is modified by ordered addition of reactive diluent from EXAMPLE 4 (283 parts), KEN-REACT NZ 38 (40 parts), KEN-REACT KZ 55 (28 parts), TRITON CF-10 (7 parts), DMAPMA (35 parts), NUOCURE COBALT DRIER 10% solution (12 parts), and NUOCURE MANGANESE DRIER (21.5 parts). This concentrated alkyd composition is referred to as Composition J.

### EXAMPLE 6

This example illustrates the production of a medium oil alkyd suitable for use in a coating composition, more preferably a composition useful as a topcoat. The following are combined in a sidearm flask: linseed oil (10 parts), isophthalic acid (2 parts), and KEN-REACT KZ 55 (0.035 parts). The mixture is heated to 150° C. for 8 to 10 hours. Reactive diluent (6.67 parts) from EXAMPLE 4 is added to produce Composition K.

Composition K is modified before addition to a coating composition. Composition K (10 parts) is gently mixed, and ingredients are added in order: KEN-REACT NZ 38 (0.3 part), KEN-REACT KZ 55 (0.2 part), TRITON CF-10 SURFACTANT (0.25 part), DMAPMA (0.25 part), NUOCURE COBALT DRIER 10% solution (0.27 parts), and NUOCURE MANGANESE DRIER 6% solution (0.37 parts). The resulting is Composition L.

### EXAMPLE 7

This example illustrates production of a coalescent composition suitable for use in a coating composition that is curable to an egg-shell or semi-gloss film. The following components are added with constant mixing: Composition A from EXAMPLE 1 (1 part), Butoxypolyglycol Basic (2 parts), SR-9035 from Sartomer (1 part), Composition M (1.38 parts), and Composition N (1 part) to produce the coalescent Composition O. Composition M is prepared separately by adding SR-444 from Sartomer (1 part) to Butoxypolyglycol Basic (1 part) while mixing. Composition N is prepared separately by heating Butoxypolyglycol Basic (3 parts) to 65-77° C. and adding B-66 ACRYLOID (2 parts) and then cooling the mixture to room temperature.

### EXAMPLE 8

This example illustrates production of a coalescent composition suitable for use in a coating composition that is curable to a flatwall film. The following components are added with constant mixing: Composition A from EXAMPLE 1 (2 part), Butoxypolyglycol Basic (2.5 parts), SR-9035 from Sartomer (1 part), and Composition N (0.50 part) from EXAMPLE 7 to produce coalescent Composition P.

### EXAMPLE 9

This example represents a coalescent composition for use in a coating composition that is curable to a film with a high gloss finish. The following components are added with constant mixing: Composition A from EXAMPLE 1 (1 part), Butoxypolyglycol Basic (1 parts), SR-9035 from Sartomer (1 part), and Composition M (0.30 part) from EXAMPLE 7 to produce coalescent Composition Q.

### EXAMPLE 10

This example represents a coating composition suitable as a primer. Composition H (1760.8 parts) from EXAMPLE 3 is slowly agitated and Composition J from EXAMPLE 5 (65.60 parts) is slowly added over the course of about one minute to produce Composition R. A letdown composition is prepared separately by mixing UCAR LATEX 626 (386.18 part) and water (745 parts). Composition R (1826.4 parts) is then slowly pumped into the letdown composition (1131.2 parts) with gentle agitation over the course of about two minutes. Composition O from EXAMPLE 7 (4.23 parts) is then added with gentle mixing, followed by UCAR POLYPHOBE TR-117 (18.52 parts), sodium nitrite (2.5 parts), and finally SR-495 (2.5 parts). SR-495 is typically added last because it is difficult to adjust the viscosity subsequently.

### EXAMPLE 11

This example represents a coating composition suitable as a primer. The following seven ingredients are combined under slight agitation: water (11.15 parts), PATCOTE 841 defoamer (0.37 part), DMAPMA (0.60 part), NUOSEPT 91 (0.07 part), Composition D from EXAMPLE 1 (0.26 part), TAMOL 850 dispersant obtained from Rohm and Haas (0.37 part), and KTPP (potassium tripolyphosphate; 0.37 part). Pigments and anti-corrosives are added under medium agitation as follows: titanium dioxide, (type rutile; 6.13 parts), yellow pigment -Sunglow Yellow 1241SY from Engelhard (0.94 part), yellow iron oxide from Bayer (0.94 part), HALOX Z-PLEX 111 zinc phosphate complex from Halox (6.41 parts), NYTAL-200 (talc from RT Vanderbilt and Co.; 6.41 parts), and SW MOLY WHITE 501 (21 parts). UCAR POLYPHOBE TR-117 (Union Carbide; 0.15 part) is then added and mixing continued for about 10 minutes until the mixture achieves a Hegman value of 4.

Water (4.84 parts) and Composition J (EXAMPLE 5; 5.73 parts) are then added and the mixture is mixed for an additional five minutes. A mix of 50% UCAR 626 acrylic resin in water (weight/weight; 18.63 parts) produces a letdown mix to which the grind mixture is slowly added, as in EXAMPLE 10. The following components are then added in order: coalescent Composition O from EXAMPLE 7 (0.15 part), water (14.16 parts), POLYPHOBE 117 (0.75 part), and sodium nitrite (0.15 part). The pH is adjusted to between about 8.8 and 8.95 using 28% ammonium hydroxide in water (0.50 part) and the viscosity adjusted to about 80-90 KU with POLYPHOBE 117. Cold temperature coalescent U7111, SR-495 from Sartomer, is then added (0.07 part) and the coating composition converted to final form by tinting with Black Lamp Paste (Creanova 802-9907; 0.13 part).

The primer compositions produced in EXAMPLES 10 and 11 show outstanding hardness, durability and adhesion. For example, the composition produced in EXAMPLE 10 was applied to a surface and tested for scrub resistance in accordance with ASTM-D2486. The film produced by this composition did not show failure at 1600 cycles. In contrast, sixteen other commercially-available coatings were inferior in this test. Two failed at about 800 cycles, whereas the other fourteen were unable to reach 400 cycles. The film produced by the composition of EXAMPLE 10 is also extremely adherent, requiring 1100-1200 psi for detachment, in accordance with ASTM-D2197. A high quality paint will generally show a value of about 500-600 psi. Furthermore, the film produced by the composition of EXAMPLE 10 is superior in resistance to salt spray, as measured by ASTM B117. Whereas most water-based products break down in the first week, the film produced by curing the composition of Example 10 lasted four weeks.

The disclosure set forth above may encompass multiple distinct inventions with independent utility. Although each of these inventions has been disclosed in its preferred form(s), the specific embodiments thereof as disclosed and illustrated herein are not to be considered in a limiting sense, because numerous variations are possible. The subject matter of the inventions includes all novel and nonobvious combinations and subcombinations of the various elements, features, functions, and/or properties disclosed herein.

The disclosure set forth above may encompass multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and nonobvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements. It is believed that the following claims particularly point out certain combinations and subcombinations that are directed to one of the disclosed inventions and are novel and nonobvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower or equal in scope to the original claims, are also regarded as included within the subject matter of the inventions of the present disclosure.

We claim:

1. A coating composition that is curable in air to a protective film, comprising a binder and a reactive diluent that comprises one or more carboxylic acids with the formula R¹—(C═O)—OH, where R¹ has 8 to 35 carbons and includes an ester linkage.

2. The coating composition of claim 1, where the coating composition has a volatile organic compound content of less than 30 grams per liter.

3. The coating composition of claim 1, where R¹ has the formula R²—(C═O)—O—R³—, R² is a moiety of 3 to 23 carbons, and R³ is a linker of 1 to 16 carbons.

4. The coating composition of claim 3, where R² has 8 to 21 carbons.

5. The coating composition of claim 3, where R³ has 2 to 4 carbons.

6. The coating composition of claim 1, where the binder is an alkyd that is present at a concentration of up to about 15% by weight.

7. The coating composition of claim 6, where the alkyd and reactive diluent are present in a weight ratio of about 5:1 to about 1:5.

8. The coating composition of claim 1, where the reactive diluent is present at a concentration of up to about 15% by weight.

9. The coating composition of claim 1, where R¹ has 18 to 23 carbons and at least one unsaturated carbon-carbon bond.

10. The coating composition of claim 1, where the reactive diluent is an ester condensation product of at least one fatty acid and a hydroxy carboxylic acid.

11. The coating composition of claim 10, where the hydroxy carboxylic acid has two to seventeen carbons.

12. The coating composition of claim 10, where the reactive diluent is an ester condensation product of a linseed oil fatty acid and lactic acid.

13. A reactive diluent mixture for use in a coating composition that is curable to a protective film, where the reactive diluent mixture is produced by ester condensation of lactic acid and a mixture of at least two fatty acids obtained from linseed oil.

14. A coating composition that is curable to a protective film, comprising an alkyd, an acrylic resin, and a coupling agent.

15. The coating composition of claim 14, where total volatile organic compound content is less than about 30 grams per liter.

16. The coating composition of claim 14, where the coupling agent is present at a concentration of up to about 2% by weight and includes titanium or zirconium.

17. The coating composition of claim 14, further comprising a reactive diluent, where the alkyd:reactive diluent weight ratio is about 5:1 to about 1:5.

18. The coating composition of claim 14, where the acrylic resin is present at a concentration of about 2% to about 20% by weight.

19. The coating composition of claim 14, further comprising a polyether polyol.

20. The coating composition of claim 19, where the polyether polyol includes an ethoxylated polyol.

21. The coating composition of claim 19, further comprising a multi-functional acrylate monomer.

22. A coating composition that is curable to a protective film, comprising:
an alkyd, where the alkyd is present at a concentration of up to about 15% by weight;
an acrylic resin, where the acrylic resin is present at a concentration of up to about 40% by weight; and
a coalescent, where the coalescent comprises a multi-functional acrylate monomer and a polyether polyol.

23. The coating composition of claim 22, where the acrylate monomer is present at a concentration of about 0.001% to about 0.5% by weight, and the polyether polyol is present at a concentration of about 0.02% to about 2% by weight.

24. The coating composition of claim 22, further comprising up to about 2% by weight of a coupling agent that includes titanium or zirconium.

25. A coating composition that is curable to a protective film after application to a surface, the composition comprising:
an acrylic resin at a concentration of up to about 40% by weight;
a coalescent comprising a multi-functional acrylate monomer and a polyether polyol; and
a coupling agent.

26. The coating composition of claim 25, where the coupling agent is present at a concentration of up to about 2% by weight and includes titanium or zirconium.

27. The coating composition of claim 25, further including an acrylamide pH modifier.

28. The coating composition of claim 27, where the acrylamide pH modifier is a tertiary amine.

29. The coating composition of claim 25, where the acrylate monomer is present at a concentration of about 0.001% to about 0.5% by weight and the polyether polyol is present at a concentration of about 0.02% to about 2% by weight.

30. A concentrated dispersion composition suitable for dilution with water, detergent, or other additives, to produce a diluted composition for pigment dispersion and preparation of a curable coating composition, the dispersion composition comprising:
a coupling agent, where the coupling agent is present at a concentration of about 1% to about 30% by weight; and
a polyether polyol, where the polyether polyol is present at a concentration of about 3% to about 60% by weight.

31. The dispersion composition of claim 30, where the coupling agent and the polyether polyol are present in a weight ratio of about 1:50 to about 2:1.

32. The dispersion composition of claim 31, where the polyether polyol includes an ethoxylated polyol.

33. The dispersion composition of claim 31, where the polyether polyol includes a butoxypolyglycol.

34. The dispersion composition of claim 30, further comprising a pH modifier at a concentration of about 2% to about 60% by weight.

35. The dispersion composition of claim 34, where the pH modifier includes an acrylamide compound.

36. The dispersion composition of claim 34, where the coupling agent and the pH modifier are present in a weight ratio of about 5:1 to about 1:20.

37. The dispersion composition of claim 31, further including a freeze-thaw stabilizer.

38. The dispersion composition of claim 37, where the freeze-thaw stabilizer includes a polyvinyl alcohol at a concentration of up to about 20% by weight.

39. The dispersion composition of claim 31, further including vanillin at a concentration of up to about 3% by weight.

40. A dispersion composition suitable for dilution with water, detergent or other additives, to produce a composition for pigment dispersion and preparation of a coating composition, the dispersion composition comprising:
a first part that comprises a coupling agent and a polyether polyol; and
a second part that is substantially aqueous and constitutes up to about 95% of the dispersion composition by weight.

41. The dispersion composition of claim 40, where the coupling agent is present in the first part at a concentration of about 1% to about 30% and includes titanium or zirconium.

42. The dispersion composition of claim 40, where the polyether polyol is present in the first part at a concentration of about 3% to about 60% by weight.

43. The dispersion composition of claim 40, where the coupling agent and the polyether polyol are present in the composition in a weight ratio of about 1:50 to about 2:1.

44. The dispersion composition of claim 40, where the composition further comprises an acrylamide pH modifier.

45. The dispersion composition of claim 40, where the pH modifier is present in the first part at a concentration of about 2% to about 60% by weight.

46. A concentrated alkyd composition for use in producing a coating composition that is curable to a protective coating and has a total volatile organic compound content less than 30 grams per liter, the alkyd composition comprising:
an alkyd that is present at a concentration of about 10% to about 80%; and
a reactive diluent that comprises one or more carboxylic acids with the formula R¹—(C═O)—OH, where R¹ has 8 to 35 carbons and includes an ester linkage.

47. The alkyd composition of claim 46, where R¹ has the formula R²—(C═O)—O—R³—, R² is a moiety of 3 to 23 carbons, and R³ is a linker of 1 to 16 carbons.

48. The alkyd composition of claim 46, where the reactive diluent is present at a concentration of about 10% to about 80% by weight.

49. The concentrated alkyd composition of claim 46, where the alkyd and the reactive diluent are present in a weight ratio of about 5:1 to about 1:5.

50. The concentrated alkyd composition of claim 46, where the alkyd is produced from an oil that comprises linseed oil or tung oil.

51. A concentrated alkyd composition for use in producing a coating composition that is curable to a protective coating and has a total volatile organic compound content less than 30 grams per liter, the alkyd composition comprising:
an alkyd present at a concentration of about 10% to about 80% by weight; and
a coupling agent present at a concentration of about 0.5% to about 15% by weight and including titanium or zirconium.

52. The alkyd composition of claim 51, further comprising a reactive diluent at a concentration of about 10% to about 80% by weight.

53. The alkyd composition of claim 52, where the reactive diluent comprises one or more carboxylic acids with the formula R¹—(C═O)—OH, and R¹ has 8 to 35 carbons and includes an ester linkage.

54. The alkyd composition of claim 51, further comprising a detergent at a concentration of about 0.01% to about 3% by weight.

55. The alkyd composition of claim 51, further comprising an acrylamide pH modifier that is present at a concentration of about 0.5% to about 10% by weight.

56. The alkyd composition of claim 51, further comprising a drying agent.

57. A concentrated coalescence composition that is suitable for use in preparing a curable coating composition, the coalescence composition comprising:
an acrylate monomer at a concentration of about 2% to about 50% by weight; and
a polyether polyol at a concentration of about 10% to about 90% by weight.

58. The coalescence composition of claim 57, further including vanillin at a concentration of up to about 2% by weight.

59. The coalescence composition of claim 58, where the vanillin and the polyether polyol are present in a weight ratio of about 1:10 to about 1:1000.

60. A method of dispersing pigment during preparation of a curable coating composition, comprising:
combining at least one pigment with a dispersion composition to produce a mixture, where the combining step results in dis-agglomeration of the pigment;
provided that the mixture comprises a titanium or zirconium coupling agent at a concentration of about 0.004% to about 1.2% by weight and a polyether polyol at a concentration of about 0.012% to about 2.4% by weight.

61. The method of claim 60, where the mixture further comprises an acrylamide pH modifier at a concentration of about 0.1% to about 10% by weight.

62. The method of claim 60, where the mixture further comprises a freeze-thaw stabilizer at a concentration of up to about 0.8% by weight.

63. The method of claim 60, further comprising diluting a concentrated dispersion composition about 10-fold to about 2000-fold to produce the dispersion composition, where the concentrated dispersion composition provides the coupling agent and the polyether polyol for the dispersion composition.

64. A method of dispersing pigment during preparation of a curable coating composition, comprising:
combining at least one pigment with a dispersion composition to produce a pigment mixture, where the combining step results in dis-agglomeration of the pigment;
provided that the pigment mixture comprises a titanium or zirconium coupling agent at a concentration of about 0.004% to about 1.2% by weight, and an acrylamide pH modifier at a concentration of about 1% to about 10% by weight.

65. The method of claim 64, further comprising diluting a concentrated dispersion composition about 10-fold to about 2000-fold to produce the dispersion composition, where the concentrated dispersion composition provides the coupling agent for the dispersion composition.

66. A method of producing a coating composition that is curable to a protective film, comprising:
mixing an alkyd composition and a water-based mixture, where the alkyd composition comprises an alkyd and a reactive diluent, the alkyd and reactive diluent are each present at a concentration of about 10% to about 80% by weight, and the alkyd is diluted about 2-fold to about 40-fold by mixing.

67. The method of claim 66, where the water-based mixture comprises at least one pigment at a concentration of at least about 30% by weight.

68. The method of claim 66, where the alkyd composition further comprises a coupling agent at a concentration of about 0.5% to about 15% by weight.

69 The method of claim 66, further comprising the step of adding an acrylic resin to a final concentration of up to about 40% by weight.

70. The method of claim 66, further comprising the step of adding a coalescent composition that includes at least two coalescents.

71. A method of producing a coating composition that is curable to a protective film, comprising:
combining a coalescent composition with a water-based mixture that includes a binder, where the coalescent composition is diluted at least about 50-fold when combined and comprises at least two coalescing agents.

72. The method of claim 71, where the binder comprises an alkyd and an acrylic resin.

73. The method of claim 71, where the at least two coalescing agents include a polyether polyol.

74. A method of producing a coating composition that is curable to a protective film, comprising the steps of:
diluting a concentrated dispersion composition about 10-fold to about 2000-fold with water and pigment to make a pigment dispersion adapted to dis-agglomerate the pigment upon mixing;
combining binder with the pigment dispersion to make a binder mix; and
combining a concentrated coalescent composition with the binder mix, where the coalescent composition is diluted at least about 50-fold when combined.

75. The method of claim 74, where the concentrated dispersion composition includes a titanium or zirconium coupling agent.

76. The method of claim 74, where combining binder includes addition of a concentrated alkyd composition, where the concentrated alkyd composition includes an alkyd at a concentration of about 10% to about 80% by weight.
